(19) United States
(12) Patent Application Publication
(10) Pub. No.: US 2008/0272857 A1
(43) Pub. Date: Nov. 6, 2008

(54) TUNABLE MILLIMETER-WAVE MEMS PHASE-SHIFTER

(75) Inventor: Donald R. Singh, Apple Valley, MN (US)

Correspondence Address: HONEYWELL INTERNATIONAL INC.;PATENT SERVICES AB-2B, 101 COLUMBIA ROAD, P.O. BOX 2245, MORRISTOWN, NJ, 07962-2245, US

(73) Assignee: HONEYWELL INTERNATIONAL INC., Morristown, NJ (US)

(21) Appl. No.: 11/744,122

(22) Filed: May 3, 2007

(51) Int. Cl. H01P 1/18

(52) U.S. Cl. 333/161

(57) ABSTRACT

A phase shifter for and a method for shifting phase in an antenna configured to emit a radio signal at a wavelength include a transmission line. The transmission line has a length along a primary axis and a width across a secondary axis. The primary axis and secondary axis intersect to define a waveguide plane. A conductive screen layer has first and second screen surfaces. The screen surfaces are substantially planar and disposed parallel to and spaced apart from the waveguide plane by a distance and are spaced apart from each other by a screen thickness much smaller than a skin depth of the screen layer determined at the wavelength. A dielectric layer envelopes the screen layer and has a first dielectric surface residing substantially in the waveguide plane and a second dielectric surface parallel to and spaced apart from the first dielectric surface by a height greater than the distance. A conductive ground plate has a ground plate surface substantially coplanar with the second dielectric surface whereby the propagation of the signal along the transmission line is slowed by a slowing factor.

### BACKGROUND OF THE INVENTION

Millimeter-waves are electromagnetic (EM) waves generally between 30 and 300 GHz with wavelengths ranging from 1 to 10 mm. A millimeter wavelength is quite long compared to optical wavelengths; the long wavelength allows millimeter-waves to penetrate many optically opaque materials.

Millimeter-wave ranging is of interest since most objects have high reflectivity in this range and the EM waves easily penetrate through dust, fog and smoke. A Moreover, a 94 GHz millimeter-wave radiometer may be capable of high resolution imaging with application to aviation safety and remote sensing. Millimeter-waves are non-ionizing, and effective imaging systems can be operated at extremely low power levels.

Experimental millimeter wave imaging sensors using mechanically scanned antenna have proven inadequate for imaging applications due to low scanning rates mechanical scanners achieve (mechanical scanning is generally limited to frequencies of fewer than 10 Hz; such frequencies being insufficient to formulate an image in a changing environment).

A scanning system for millimeter-wave imaging can be achieved in an antenna beam formed by the superposition of reflected/radiated EM waves from the array elements. For millimeter-wave antenna, these elements are, typically, microstrip patch antenna on a planar dielectric substrate. Scanning by means of beam steering can be achieved if a tunable delay (known as a phase-shift) can be incorporated in a design of the microstrip elements, in order to shape the reflected/radiated waves in accord with the delay.

Although, Microelectromechinical System (“MEMS”) based millimeter-wave phase-shifters have been developed, they have relatively large size, and have a limited tuning range. Additionally, current MEMS phase-shifters suffer from unpredictable changes of their characteristic impedance during tuning.

Thus, to effect beam steering, there is an unmet need in the art for a millimeter wave phase-shifters. What is needed is a phase-shifter that relies upon slow wave propagation thereby resulting in the phase-shifter having a compact size and low-dispersion, as well as a large capacity for tuning. Ideally such as phase-shifter will also demonstrate low energy loss and relatively constant impedance in use making it suitable for integration with monolithic microwave integrated circuits, hybrid planar circuits, and planar antenna structures to realize electronic scanning.

### SUMMARY OF THE INVENTION

A phase shifter for and a method for shifting phase in an antenna configured to emit a radio signal at a wavelength include a transmission line. The transmission line has a length along a primary axis and a width across a secondary axis. The primary axis and secondary axis intersect to define a waveguide plane. A conductive screen layer has first and second screen surfaces. The screen surfaces are substantially planar and disposed parallel to and spaced apart from the waveguide plane by a distance and are spaced apart from each other by a screen thickness much smaller than a skin depth of the screen layer determined at the wavelength. A dielectric layer envelopes the screen layer and has a first dielectric surface residing substantially in the waveguide plane and a second dielectric surface parallel to and spaced apart from the first dielectric surface by a height greater than the distance. A conductive ground plate has a ground plate surface substantially coplanar with the second dielectric surface whereby the propagation of the signal along the transmission line is slowed by a slowing factor.

A very thin (much less than skin depth) metal screen is embedded in a dielectric layer and is configured to spatially separate the electric and magnetic fields of an electromagnetic (“EM”) wave propagates along a transmission line. A resulting spatial separation between the electric and magnetic fields results in the classic “slow-wave” mode of EM propagation thereby delaying a the EM wave with a slowing factor. Exploiting the slow wave mode of EM propagation results in low dispersion, low-loss, and compact size.

In a non-limiting embodiment, a phase-velocity of the propagated EM wave was slowed by a factor of greater than 15 with relatively low-loss, and extremely low-dispersion as well as a wide range (20-100) of highly controlled characteristic impedance over a wide frequency range (0.01-40 GHz). The non-limiting embodiment exhibited a fixed time delay (˜70 picoseconds/mm) or phase shifts (greater than 360 degrees/mm) at 40 GHz.

In another non-liming embodiment, a tunable phase-shifter exploits the metal screen to form an electrostatically actuated air bridge effective for tuning the phase-shifter for frequencies up to at least 100 GHz. As configured, the electrostatically actuated air bridge structure requires low actuation voltages. To further enable tuning air bridge sections are controlled individually allowing robust digital phase control.

As will be readily appreciated from the foregoing summary, the invention provides a phase-shifter that relies upon slow wave propagation having a compact size and low-dispersion, as well as a large capacity for tuning.

### BRIEF DESCRIPTION OF THE DRAWINGS

Preferred and alternative embodiments of the present invention are described in detail below with reference to the following drawings:

FIG. 1 is a cross-sectional view of a transmission line having a metal screen layer;

FIG. 2 is an isometric view of the transmission line having the metal screen layer and showing linear elements according to an embodiment of the present invention; and

FIGS. 3a and b are a cross-sectional views of one of a plurality of air bridges periodically straddling the transmission line.

### DETAILED DESCRIPTION OF THE PREFERRED EMBODIMENT

In wave theory, an antenna can be created to shape a radiated signal by energizing elements of an antenna with signals that interfere with one another. An antenna array is a plurality of antenna elements coupled to a common source or load to produce a directive radiation pattern. Usually the spatial relationship also contributes to the directivity of the antenna. For example, a phased-array is a group of antenna elements radiating signals wherein the relative phases of the respective signals feeding each of the antenna elements are offset relative to one another in such a way that the effective radiation pattern of the array is reinforced in a desired direction and suppressed in undesired directions. Phased-array technology was originally developed by the then-future Nobel Laureate Luis Alvarez during World War II to facilitate a rapidly-steerable radar system to aid pilots in the landing of airplanes in England. Other phased-radiation array technologies, such as aperture synthesis also use phased radiation from distinct antenna elements to shape the effective radiation pattern.

To achieve phase delays of a signal emanating from any one of the antenna elements, given the speed of propagation over a standard waveguide, developing wave paths long enough to achieve, for example, quarter wavelength delays, is not practical. Rather, slowing propagation over a more-practically sized waveguides will suitably achieve the necessary phase-delay. A phenomenon known as slow wave propagation can be advantageously used to delay propagation of a signal.

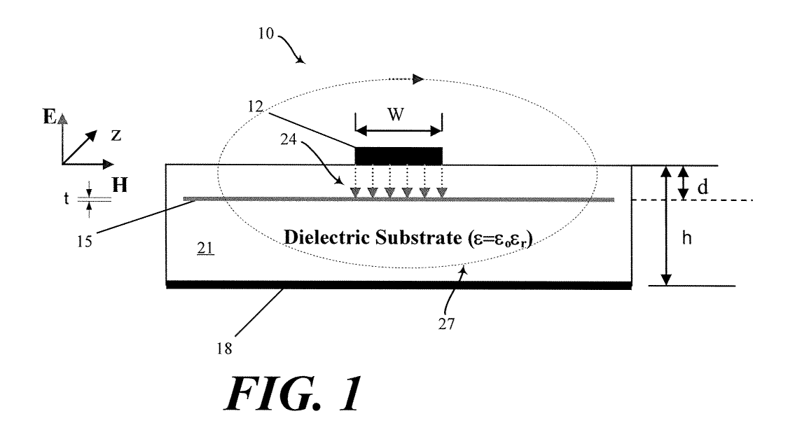

Referring to FIG. 1, a RF signal energizing a microstrip transmission line structure may be used as a structure 10 for slow wave propagation. A top metal trace forming a transmission line 12 of width w is situated on a dielectric substrate 21 with a metal ground plane 18 and a buried thin metal screen layer 15. The metal screen layer 15 has a thickness t chosen to be very much smaller than a skin depth □m, at millimeter-wave frequencies Skin depth is a term used for the depth at which the amplitude of an electromagnetic wave attenuates to 1/e of its original value. The skin depth of a material can be calculated from the relative permeability μ conductivity of the metal and the frequency of operation. The dominant mode of propagation along the transmission line 12 is quasi-transverse electromagnetic wave (quasi-TEM).

The presence of the thin metal screen layer 15 confines electric fields 24 (alternately referred to as the “E” fields) to a region within the dielectric 21 between the transmission line 12 and the screen metal layer 15. Moreover, since t<<δₘ, magnetic fields (alternately referred to as “H” fields 27) freely penetrate the screen metal layer. The H fields 27 reside largely in the dielectric substrate 21 bounded by the bottom metal ground plane 18. Because the screen metal layer 15 forces the E field 24 and H field 27 to occupy distinct volumes in space, propagation of a wave along the transmission line 12 is according to classic slow-wave propagation. Slow wave propagation, typically, produces a large and predictable decrease in phase velocity. In contrast, in a conventional transmission line, i.e. where the E and H fields occupy the same volumes in space, the phase velocity along the exemplary transmission line 12 is well approximated by

$${v}_{p} \approx \frac{{v}_{o}}{\sqrt{{ɛ}_{r}}} ,$$

where υₒ is free space velocity.

The slow wave propagation phenomenon can also be well described using transmission line theory. Referring again to FIG. 1, a propagation constant and phase velocity of a lossless transmission line 12 are given, respectively, as β=ω┐/L, and

$${v}_{p} = \frac{1}{\sqrt{LC}} ,$$

where L and C are the inductance and capacitance per unit length along the transmission line 12. According to such classical boundary conditions, slow-wave propagation can be accomplished by effectively increasing the L and C values. In the case described by FIG. 1, neglecting fringing fields and their effects:

$$\begin{matrix}C = \frac{{ɛ}_{o} {ɛ}_{r} w}{d} & ( \begin{matrix}parallel plate capacitor ; dielectric between top \\ metal conductor and screen layer metal\end{matrix} ) and \\ L \approx \frac{{μ}_{o} h}{w} & ( inductance of standard microstrip line )\end{matrix}$$

$$Hence , \\ {v}_{p} = \frac{1}{\sqrt{LC}} = \frac{1}{\sqrt{{ɛ}_{o} {ɛ}_{r} {μ}_{o} \frac{h}{d}}} = \frac{{v}_{o}}{\sqrt{{ɛ}_{r}}} \frac{1}{\sqrt{\frac{h}{d}}}$$

The screen metal layer 15 is advantageously positioned such that (in the non-limiting embodiment set forth in FIG. 1) typically, d (a distance between the transmission line 12 and the screen metal layer 15) is chosen to be on the order of few microns, whereas h (a height of the dielectric substrate 21 separating the transmission line from a grounding plane) is selected to be in the 100-250 microns range for adequate characteristic impedance (Zo˜50Ω). Selecting the dimensions d and h advantageously, causes the slowing factor (the ratio relating the propagation velocity in free space to the propagation velocity along the transmission line

$$SF = \frac{{v}_{o}}{{v}_{p}} )$$

to be at least ten times larger than that of the wave propagating in a standard dielectric 21 transmission line 15 expressed as

$$SF \approx \frac{1}{\sqrt{{ɛ}_{r}}} .$$

By confining the E field 24 with the metal screen layer 15 while allowing the H field 27 to extend to the ground plate 18 (because the thickness t of the metal screen layer 15 is much smaller than the skin depth at the highest frequency of operation), slow wave propagation is achieved.

As indicated above, slow-wave propagation is accomplished by effectively increasing the L and C values. Two ways exist to further enhance the capacitance of the transmission line. First, adding additional grounded plates in proximity to the transmission line. Second, by adding periodic adjustable discrete capacitive air-bridge loading to the transmission line. This also reduces the overall losses in the transmission line or phase shifter.

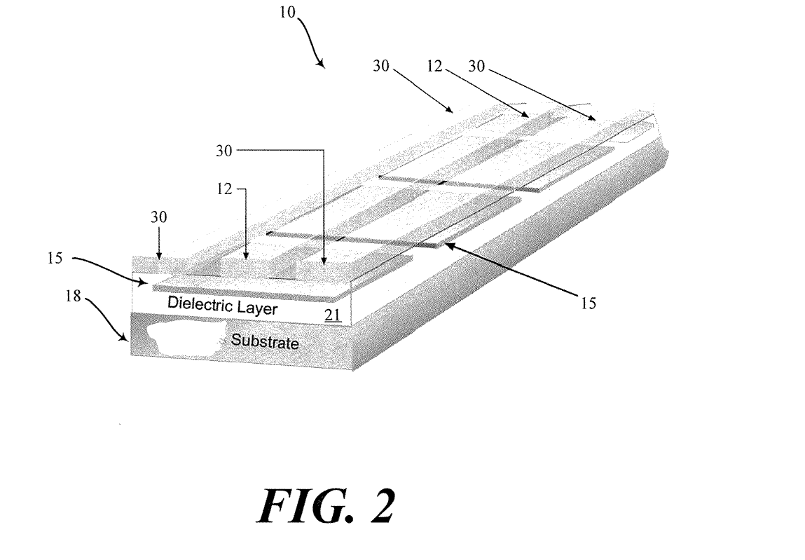

Referring to FIG. 2, the transmission line 12 of FIG. 1 is portrayed as a component of a coplanar structure 10 with additional linear elements 30 within a plane parallel to the dielectric substrate and containing the transmission line 12. Just as the transmission line 12 forms a classic capacitor with the ground plate 18, the transmission line 12 similarly forms capacitors with each of the linear elements 30. Conductive paths (not shown) connect the linear elements 30 to the ground plate 18 adding to the overall capacitive loading of the transmission line 12. Adding to the overall capacitive loading, the presence of these linear elements 30 further enhances slow wave propagation along the transmission line 12.

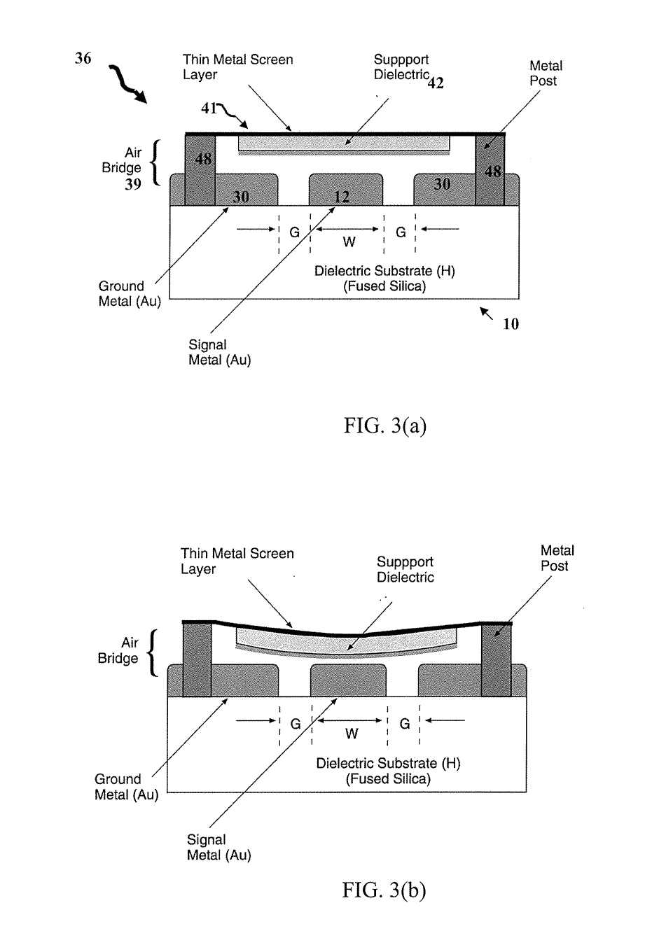

As shown in FIGS. 3a, b, slow wave propagation along the transmission line 12 is further enhanced by the addition of an adjustable discrete capacitive air-bridge 39 loading placed periodically along the transmission line 12. FIG. 3a shows the beam element 41 in a first position while FIG. 3b shows the beam element 41 in a second position due to a placement of charge diminishing a distance between the thin metal screen 41 and the transmission line 12 within the airbridge 39. Air bridges 39 are placed along the transmission line 12 at intervals that occur with reference to a Bragg frequency.

A distributed Bragg reflector (DBR) is a high quality reflector used in waveguides, such as transmission lines 12. Periodic variation of some characteristic (such as local capacitance) of a dielectric waveguide results in periodic variation in the effective refractive index in the waveguide (capacitive loading). Each occurrence of the periodic variation causes a partial reflection of the TEM wave. For waves whose wavelength is close to four times the period of the variation, the many reflections along the transmission line 12 combine with constructive interference.

The Bragg frequency in the case of the air bridge 39 is the frequency at which the individual reflections from each of the periodically spaced air-bridges add up in phase to maximize internal reflection along the transmission line. Optimal reflection occurs at a frequency such that the spacing between the capacitors is ¼ of a wavelength on the transmission line. The distance interval, however, is not exactly ¼ wave because of the effects of capacitive loading and inherent shunt inductance of the air-bridges 39.

A phase-shifter 36 includes the wave guide 10 (shown here, for clarity, as a monolith and in detail in FIG. 2) including the linear elements 30 spaced apart from the transmission line 12, and situated upon the transmission line one of a plurality of periodically spaced air bridges 39, shown here in cross-section.

The air bridge 39 includes a conductive fixed-fixed beam 41 traversing the transmission line 12 in perpendicular relationship. While the fixed-fixed beam 41 is discussed as a non-limiting embodiment, other configurations of the beam 41 may be advantageously used. The beam 41 elements are readily formed of a dielectric substrate 42 using microelectromechanical system (“MEMS”) procedures. In the context of MEMS procedures, beams 41 are commonly described using a descriptor referring to a presence of one or two anchoring points 48 on either or both extreme ends of the beam 41. Referring to the non-limiting exemplary embodiment of FIG. 3a, b, the beam 41 is fixed at a first and a second anchor point 48 making the description of the beam 41 as a fixed-fixed beam 41 apt.

To suitably form a periodic capacitive element for Bragg reflection on the transmission line 12, the fixed-fixed beam 41 must have the capacity to receive an electric charge. To that end, the beam is made conductive, either by suitable selection of constituent materials or by applying a metal trace 45 to the dielectric substrate 42 by deposition. As discussed above, the anchor points 48 are electrically connected to the parallel linear elements 30 in a plane parallel to the ground plate 18 (FIGS. 1, 2) and containing the transmission line 12. The fixed-fixed beam 41 is grounded by virtue of electrical connection to the linear elements 30 and situated to straddle the transmission line 12. When a pull down voltage (D.C. voltage) is applied between the transmission line 12 and the ground available at the metal trace 45, electrostatic forces cause the bridge 41 to flex to an actuation position, moving from an “up-state” to a “down-state” (pictured in the up-state).

When the bridge 41 is in the up-state, as shown in FIG. 3a, it provides the low capacitance relative to ground, and the presence of the bridge 41 does not greatly affect signal on the transmission line 12. When the bridge is actuated in the down-state, as shown in FIG. 3b, the capacitance relative to ground becomes higher and movement to the down-state results in periodic locally high capacitive nodes yielding high slowing of EM waves at microwave and millimeter wave frequencies. This results in large phase shifts and low loss in the phase shifter.

While the preferred embodiment of the invention has been illustrated and described, as noted above, many changes can be made without departing from the spirit and scope of the invention. For example, a fixed-floating bridge might be advantageously employed in place of the fixed-fixed bridge. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A phase-shifter operating at RF frequencies comprising:
a transmission line having a length along a primary axis and a width across a secondary axis, the primary axis and secondary axis intersecting thus defining a waveguide plane;
a conductive screen layer having first and second screen surfaces, the screen surfaces being substantially planar and disposed parallel to and spaced apart from the waveguide plane by a distance screen layer having a thickness much smaller than a skin depth of the screen layer based upon the wavelength;
a dielectric layer enveloping the screen layer and having a first dielectric surface residing substantially in the waveguide plane and a second dielectric surface parallel to and spaced apart from the first dielectric surface by a height greater than the distance; and
a conductive ground plate having a ground plate surface substantially coplanar with the second dielectric surface whereby propagation of the signal along the transmission line is slowed by a slowing factor.

2. The phase-shifter of claim 1, further comprising at least one linear element, the linear element having a linear axes being disposed in the waveguide plane parallel to the primary axis and spaced apart from the primary axis by a separation, the linear elements being in conductive connection with the ground plate.

3. The phase-shifter of claim 1, further comprising at least one air bridge, the air bridge comprising:
a conductive fixed-fixed beam having a beam axis disposed in a generally parallel relationship to the secondary axis and spaced apart from the transmission line, the beam being responsive to a pull down voltage applied between the transmission line and the fixed-fixed beam thereby increasing a distributed capacitive loading along the transmission line.

4. The phase-shifter of claim 3, wherein the at least one air bridge includes a first and a second air bridge spaced apart by a air bridge interval along the primary axis, the first air bridge being responsive to a first pull down voltage and the second air bridge being responsive to a second pull down voltage.

5. The phase-shifter of claim 4, wherein the air bridge interval is approximately one quarter of a wavelength.

6. The phase-shifter of claim 1, wherein the height is selected to be at least ten times the magnitude of the distance.

7. A method for slowing propagation of a signal having a wavelength on a transmission line, the method comprising:
energizing a transmission line parallel to a conductive ground plate with a signal at the wavelength, the transmission line being spaced apart from the ground plate by a height and having a length along a primary axis and a width across a secondary axis, the primary axis and secondary axis intersecting to define a waveguide plane;
interposing a conductive screen layer spaced apart from the waveguide plane by a distance smaller than the height and having first and second screen surfaces, the screen surfaces being substantially planar and disposed parallel to and being spaced apart from each other by a screen thickness much smaller than a skin depth of the screen layer determined at the wavelength whereby the screen layer confines the electric field while allowing the magnetic field to extend to the ground plate thereby slowing propagation of the signal along the transmission line by a slowing factor.

8. The method of claim 7, further comprising:
enveloping screen layer with a dielectric.

9. The method of claim 7, further comprising:
providing first and second linear elements, the linear elements having linear axes being disposed in the waveguide plane in opposing relationship and parallel to spaced apart from the primary axis by a separation, the linear elements being in conductive contact with the ground plate.

10. The method of claim 7, further comprising:
supplying a pull down voltage between the transmission line and at least one conductive fixed-fixed beam having a beam axis disposed in a generally parallel relationship to the secondary axis, the beam being responsive to the pull down voltage thereby increasing a distributed capacitive loading along the transmission line.

11. The method of claim 10, wherein the at least one air bridge includes a first and a second air bridge spaced apart by a air bridge interval along the primary axis, the first air bridge being responsive to a first pull down voltage and the second air bridge being responsive to a second pull down voltage.

12. The method of claim 11, wherein the air bridge interval is approximately one quarter of a wavelength.

13. The method of claim 1, wherein the height is selected to be at least ten times the magnitude of the distance.
